(19) United States
(12) Patent Application Publication
(10) Pub. No.: US 2026/0010980 A1
(43) Pub. Date: Jan. 8, 2026

(54) DIFFUSION-BASED IMAGE TRANSLATION SYSTEM AND METHOD WITHOUT REQUIRING RETRAINING

(71) Applicant: ELECTRONICS AND TELECOMMUNICATIONS RESEARCH INSTITUTE, Daejeon (KR)

(72) Inventors: MINHO PARK, Daejeon (KR); Dong-oh Kang, Daejeon (KR)

(21) Appl. No.: 19/257,199

(22) Filed: Jul. 1, 2025

(30) Foreign Application Priority Data
Jul. 5, 2024 (KR) 10-2024-0088862

(51) Int. Cl. G06T 5/60; G06T 3/04; G06T 5/70; G06T 11/00

(52) U.S. Cl. CPC G06T 5/60; G06T 3/04; G06T 5/70; G06T 11/00; G06T 2207/20081; G06T 2207/20084; G06T 2210/32

(57) ABSTRACT

Disclosed are a diffusion-based image translation system and method without requiring retraining. The diffusion-based image translation method without requiring retraining includes (a) generating a prompt using information obtained from an image dataset, (b) training a text-to-image generation diffusion model using the prompt, and (c) performing image translation using the text-to-image generation diffusion model.

### CROSS-REFERENCE TO RELATED APPLICATION

The present application claims priority to and the benefit of Korean Patent Application No. 10-2024-0088862, filed on Jul. 5, 2024, in the Korean Intellectual Property Office, the entire disclosure of which is incorporated herein by reference.

### BACKGROUND

### 1. Technical Field

The present disclosure relates to a diffusion-based image translation system and method without requiring retraining.

### 2. Description of Related Art

A Generative Adversarial Network (GAN), which is one of image translation technologies, is advantageous in that generated images closely mimic the distribution of real images through adversarial training between a generator and a discriminator, but is problematic in that, when a domain desired to be translated is changed, retraining needs to be performed and the quality of translated images is low.

### SUMMARY

Embodiments of the present disclosure are directed to providing a diffusion model-based system and method, which can perform image translation between multiple domains by utilizing a deep learning computer vision algorithm technique, without requiring retraining.

A diffusion-based image translation method without requiring retraining according to embodiments of the present disclosure may include (a) generating a prompt using information obtained from an image dataset, (b) training a text-to-image generation diffusion model using the prompt, and (c) performing image translation using the text-to-image generation diffusion model.

An edit prompt included in the prompt may have a format in which only a word related to a relevant domain is modified in an input prompt corresponding to description of an original image.

The text-to-image generation diffusion model may include a text encoder for text encoding, a U-Net composed of convolutional layers for denoising, and an image decoder for image generation.

(c) may include improving a quality of a translated image by delivering information about a translation target domain and a translation target image area to an image translation model.

(c) may further include acquiring a noisy image using a Denoising Diffusion Implicit Model (DDIM) process, and obtaining information about a portion that needs to be modified in an image translation process using a prompt-to-prompt algorithm.

(c) may include, when a target domain is input to the text-to-image generation diffusion model trained with a prompt having a desired format, performing translation into an image of a desired domain without requiring retraining.

(c) may include performing translation using a segmentation mask in consideration of a need to preserve image context information.

(c) may include performing control related to a time step that is a target of information delivery in a denoising process.

A diffusion-based image translation system without requiring retraining according to embodiments of the present disclosure may include a memory configured to store a program for generating a prompt using information obtained from an image dataset and training a text-to-image generation diffusion model using the prompt, and a processor configured to execute the program, wherein the processor performs image translation using the text-to-image generation diffusion model.

The text-to-image generation diffusion model may include a text encoder for text encoding, a U-Net composed of convolutional layers for denoising, and an image decoder for image generation.

The processor may perform image translation by acquiring a noisy image using a Denoising Diffusion Implicit Model (DDIM) process and by obtaining information about a portion that needs to be modified in an image translation process using a prompt-to-prompt algorithm.

The processor may perform translation into an image of a desired domain without requiring retraining, as a target domain is input to the text-to-image generation diffusion model trained with a prompt having a desired format.

The processor may perform translation using a segmentation mask in consideration of information that needs to be preserved.

The processor may perform control related to a time step that is a target of information delivery in a denoising process.

According to the present disclosure, in image translation techniques aimed at image editing, modification, or data augmentation, it is possible to perform multi-domain translation without requiring retraining, and to improve the quality of translated images.

According to the present disclosure, a diffusion model-based deep learning network for multi-domain translation is presented, and a training and translation framework divided into two stages for the corresponding network training is proposed. Based on the diffusion model-based deep learning network and the training and translation framework, high-quality images belonging to a desired target domain may be generated, and excellent performance may be ensured compared to conventional models.

According to the present disclosure, information requiring form preservation in a translation process is delivered using a segmentation mask, thus obtaining the effect of improving a translated image to completely preserve the form of the corresponding object.

The effects of the present disclosure are not limited to those mentioned above, and other effects not explicitly stated will be clearly understood by those skilled in the art from the following description.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings:

FIG. 1 illustrates a process of training a generative adversarial network.

FIG. 2 illustrates an image translation method without requiring retraining according to an embodiment of the present disclosure.

FIG. 3 illustrates a fine-training process of a text-to-image translation model according to an embodiment of the present disclosure.

FIG. 4 illustrates a process of performing image translation inference based on information obtained from a trained T2I model and additional three modules according to an embodiment of the present disclosure.

FIG. 5 illustrates the results of performance comparison between the model of the present disclosure and other conventional image translation models in BDD100K that is a dataset representatively used for image translation performance measurement.

FIG. 6 illustrates the results of a quality comparison between images translated by a model according to an embodiment of the present disclosure.

FIG. 7 illustrates result images obtained by translating an image into multiple domains using a model according to an embodiment of the present disclosure.

FIG. 8 illustrates the results of a qualitative comparison in image translation performance between a model according to an embodiment of the present disclosure and conventional models.

FIG. 9 illustrates a histogram of CLIP-IQA scores for respective tasks corresponding to Tᵢₙⱼ according to an embodiment of the present disclosure.

FIG. 10 illustrates the results of images generated depending on Tᵢₙⱼ values and CLIP-IQA scores according to an embodiment of the present disclosure.

FIG. 11 illustrates the results of performance changes depending on whether training using a prompt and a segmentation mask are used according to an embodiment of the present disclosure.

FIG. 12 is a block diagram illustrating a computer system for implementing a method according to an embodiment of the present disclosure.

### DETAILED DESCRIPTION OF THE INVENTION

The above object and other objects, advantages and features of the present disclosure, and methods for achieving the same will be cleared with reference to embodiments described later in detail together with the accompanying drawings.

However, the present disclosure is not limited to the embodiments disclosed below, and may be implemented in various other forms. The following embodiments are merely provided to enable those skilled in the art to easily understand the objects, configuration, and effects of the present disclosure. The scope of the present disclosure should be defined by the description of the accompanying claims.

Meanwhile, the terminology used in the present specification is intended solely for the purpose of describing embodiments and is not intended to limit the scope of the present disclosure. In the present specification, the singular forms also include the plural forms unless the context clearly indicates otherwise. The terms “comprises” and/or “comprising” used in the specification are merely intended to indicate that components, steps, operations, and/or elements described below are present, and do not exclude the presence or addition of one or more other components, steps, operations, and/or elements.

Image-to-Image translation refers to a process of transforming one image into another image, and is one of the key topics handled in computer vision and image processing fields. Generative Adversarial Network (GAN) technology is one of the most widely known methods for image-to-image translation, and includes modules chiefly divided into a generator and a discriminator for training purposes. The generator attempts to translate an input image into an image of another domain, and the discriminator is trained to distinguish a translated image into a real image. The generator trained in this manner may generate an image difficult to distinguish from the real image.

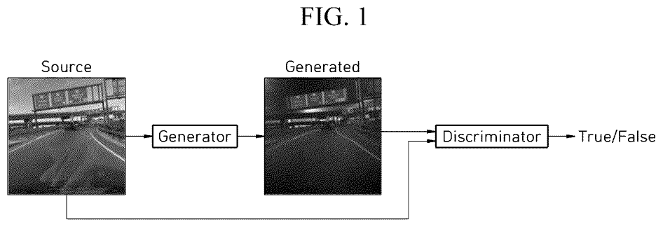

FIG. 1 illustrates a process of training a generative adversarial network. A generator receives an input image (source) and translates the input image into a desired domain. A discriminator receives a generated image and the input image, and outputs True or False. The discriminator is trained to classify the real image as True and classify the generated image as False, and the generator is trained to generate an image that can deceive the discriminator into classifying the generated image as True.

An image generated through adversarial training between the generator and the discriminator may closely mimic the distribution of the real image, but such adversarial training has several disadvantages. Representative disadvantages include a need for retraining when the target domain to be translated changes (bidirectional domain fixation), and the issue of low quality in translated images (low fidelity).

The present disclosure is intended to solve the above-described problems, and proposes a diffusion model-based system and method, which can perform image translation between multiple domains by utilizing a deep learning computer vision algorithm technique, without requiring retraining.

According to an embodiment of the present disclosure, the disadvantage of conventional technology in which model retraining is needed when a domain changes may be overcome, and translated images having high fidelity may be generated. Therefore, the present disclosure may be applied to services such as image modification and editing, data augmentation, and Simulation-to-Reality (Sim2Real) in robot simulation.

According to an embodiment of the present disclosure, it is possible to perform multi-domain translation, without requiring retraining, and to improve the quality of the translated images in image translation techniques aimed at image editing, modification, or data augmentation.

According to an embodiment of the present disclosure, a diffusion model-based deep learning network for multi-domain translation is presented, and a training and translation framework divided into two stages for the corresponding network training is proposed. Based on the diffusion model-based deep learning network and the training and translation framework, high-quality images belonging to a desired target domain may be generated, and excellent performance may be ensured compared to conventional models.

According to an embodiment of the present disclosure, information requiring form preservation in a translation process is delivered using a segmentation mask, thus obtaining the effect of improving a translated image to completely preserve the form of the corresponding object.

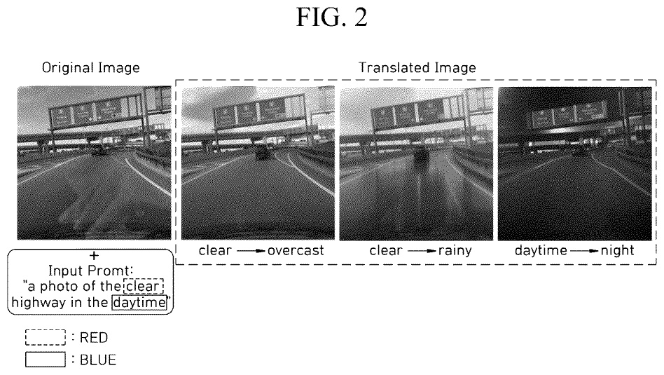

FIG. 2 illustrates an image translation method without requiring retraining according to an embodiment of the present disclosure.

An original image desired to be translated and the description of the corresponding image (input prompt) are given. The description of the corresponding image may have sentence structures with various forms, and may contain information about domains desired to be translated.

Referring to FIG. 2, the description of the corresponding image is “a photo of the clear highway in the daytime,” and the domains desired to be translated are weather and time of day, and thus information related to weather “clear” and information related to time of day “daytime” are included in the sentence.

An existing image and the description of the corresponding image are delivered to an image translation model, along with an edit prompt that includes desired domain information. The edit prompt has a format in which only a word related to the relevant domain is modified in the description (input prompt) of the corresponding image.

For example, when it is desired to translate weather from clear to rainy, the edit prompt becomes “a photo of the rainy highway in the daytime,” which is obtained by replacing “clear” with “rainy” in the above sentence provided as the input prompt. By means of this scheme, an image translated into a desired domain may be acquired.

In order to perform the above-described functions, processes divided into two stages, that is, training and inference, are performed according to an embodiment of the present disclosure.

Conventional diffusion model-based image translation methods may fetch parameters pre-trained with a large amount of data and use the parameters for inference. Here, a problem may arise in that, when an image in a distribution, not used for training, is given, image translation cannot be normally performed. In order to supplement such a problem, a process of fine-tuning training parameters for a desired specific dataset is required.

According to an embodiment of the present disclosure, image translation based on a prompt is proposed, and for this, a diffusion model for text-to-image translation is used.

Three modules, that is, Denoising Diffusion Implicit Model (DDIM) inversion, prompt-to-prompt, and label selection modules, are used to perform image translation inference using a fine-tuned text-to-image translation model.

Through the DDIM inversion module, a noisy image of the original image may be acquired, through the prompt-to-prompt module, information about a target domain desired to be translated may be obtained, and through the label selection module, information that needs to be preserved during translation may be obtained. It is possible to acquire images translated into desired domains based on pieces of information obtained through the above-described process.

Hereinafter, fine-tuning of a text-to-image translation model based on a target image dataset according to an embodiment of the present disclosure will be described.

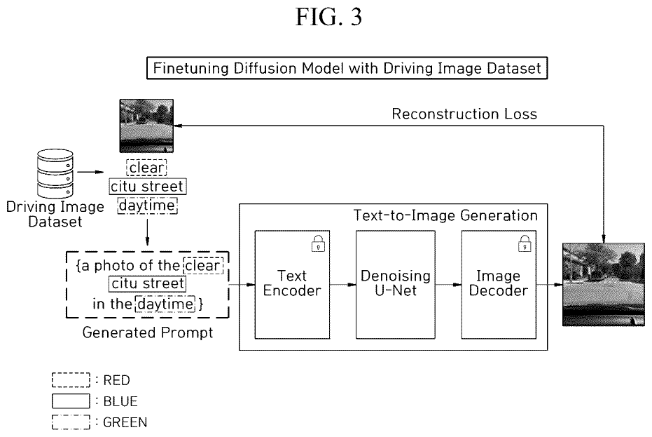

FIG. 3 illustrates a fine-training process of a text-to-image translation model according to an embodiment of the present disclosure.

FIG. 3 illustrates an example in which the range of an image desired to be translated is defined as a driving image dataset indicating image data for autonomous driving. The driving image dataset includes images captured on the road and pieces of information related to each image (e.g., weather, place, and time of day).

According to an embodiment of the present disclosure, a prompt may be generated based on the pieces of information, and a sentence form may be defined in various manners. In an example, the prompt may be “a photo of the {weather} {scene} in the {time of day}.” The prompt is used by filling {weather}, {scene}, and {time of day} with pieces of image information respectively obtained from the dataset.

Referring to FIG. 3, pieces of annotation information for the image, such as ‘clear’, ‘city street’, and ‘daytime’, are inserted and then the sentence ‘a photo of the clear city street in the daytime’ is generated.

A Text-to-Image Generation (T2I) model based on a diffusion model includes a text encoder for encoding text, a U-Net composed of convolutional layers for denoising, and an image decoder for image generation. After all of the text encoder, the denoising U-Net, and the image decoder are initialized with pre-trained parameters, they proceed to training. The parameters of the text encoder and the image decoder are fixed for training efficiency, and only the parameters of the denoising U-Net are updated. When a generated sentence is inserted, as input, into the text encoder, an image is generated through the three modules, and the T2I model is trained to reduce the difference with a real image. An objective function used here is represented by the following Equation 1:

$$L = {ω}_{t} MSE ( {u}_{θ} ( {α}_{t} I + {σ}_{t} ε , c ) - I ) \qquad [ Equation 1 ]$$

I and c denote a ground-truth image and a text prompt, and ε denotes a noise map having a standard normal distribution. u_{θ} denotes the denoising U-Net, and ωₜ, αₜ, and σₜ denote terms varying with a diffusion process time t. When training is terminated with the corresponding loss, a driving image that matches the prompt generated according to the scheme proposed by the diffusion model-based T2I is generated.

Hereinafter, image translation inference based on a trained model according to an embodiment of the present disclosure will be described.

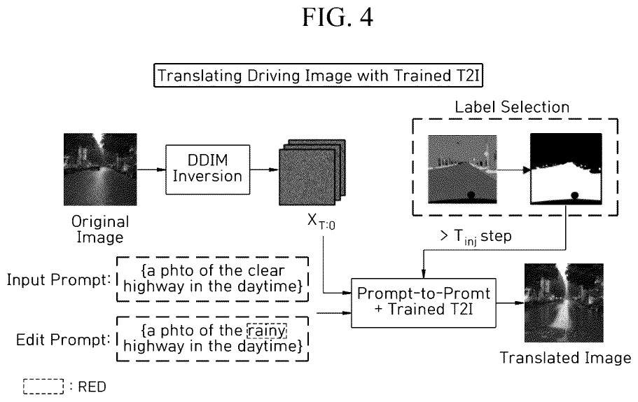

FIG. 4 illustrates a process of performing image translation inference based on information obtained from a trained T2I model and additional three modules according to an embodiment of the present disclosure.

When the T2I model is trained, random noise is used together with a latent vector obtained through a text prompt. In this case, when noise obtained through a forward noising process for an input image, instead of the random noise, is used, an image may be generated based on the context of the original image.

Further, a Denoising Diffusion Probabilistic Model (DDPM) used as a noising process in conventional diffusion models is disadvantageous in that accuracy is reduced and processing speed is low due to the probabilistic properties thereof.

According to an embodiment of the present disclosure, it is possible to quickly obtain a noisy image by using a Denoising Diffusion Implicit Model (DDIM) process.

Referring to FIG. 4, the obtained noisy image is X_{T:0} and is transferred as input, instead of random noise of T2I. A prompt, together with random noise, is transferred, wherein the format of the prompt is identical to the one used when a sentence is generated in the above-described process.

Further, an edit prompt modified from the input prompt to reflect a desired domain is also transferred to deliver information about the desired domain, along with the input prompt. In this case, a prompt-to-prompt algorithm is used to obtain information on portions that need to be modified in an image translation process.

Finally, although domain translation is important in image translation, the necessity to preserve context information of the overall image is taken into consideration. For example, there is a need to preserve pieces of information about surrounding vehicles, road, pedestrians, and the like while changing weather in the case where image translation is performed on a driving image. For this, a segmentation mask that enables the location information of the corresponding portions to be transferred at the pixel level is used. By delivering a mask in which pixels to be preserved have a value of 1 and the remaining portions have a value of 0 to a translation model, the corresponding portions may retain the characteristics of the original image as much as possible.

Also, to enable a natural translation, a variable Tᵢₙⱼ is introduced to control up to which time step the information is to be delivered during the denoising process. When the information is delivered over more steps during the process, the corresponding image may be preserved in form that is very close to the original image. On the other hand, when the information is delivered over fewer steps, the corresponding information is transformed into a form that blends more naturally with the surrounding environment. This process is represented by the following Equation 2.

$$\text{?} := \{ \begin{matrix}M \times {x}_{t} + ( 1 - M ) \times {y}_{t} , & if t > {T}_{inj} \\ {y}_{t} , & otherwise\end{matrix} \text{?} \qquad [ Equation 2 ]$$

$$\text{?} \text{indicates text missing or illegible when filed}$$

M denotes a segmentation mask, and xₜ and yₜ denote an original noisy image and a noisy image subjected to the denoising process, respectively.

According to another embodiment of the present disclosure, variables may be tuned depending on the feature information of objects included in the edit prompt during a denoising process. For example, in the case of image translation related to weather, such as a snowy scene, the degree to which the original image is preserved may be adjusted differently for objects where snow tends to accumulate (e.g., street trees or parked vehicles along the roadside) and for objects where snow do not appear to accumulate within a camera's view (e.g., traffic lights or building signs).

According to a further embodiment of the present disclosure, it is possible to adjust variables during the denoising process by comprehensively considering the characteristic information of objects and context information (e.g., weather or area) included in the edit prompt. For example, in the case of translating an image to depict a scene during cherry blossom season, assuming that image translation is performed in a situation in which the corresponding region is known to have densely planted cherry trees along the streets and the wind is blowing above a predefined wind speed, the image may be translated in a more natural form in harmony with the surrounding environment in consideration of not only the color of the objects (cherry trees or petals) but also the position of the objects (petals) (e.g., position where the petals are scattered from tree branches into the surrounding area) and dynamic information thereof (e.g., areas and speed of scattering of petals).

According to an embodiment of the present disclosure, after the prompt is generated and the T2I model is trained once, additional training is not required. In case that there is a domain desired to be translated, when information about the domain is delivered to the T2I model using an edit prompt, in which information of the corresponding domain is modified in an input prompt, the original image is translated into an image suitable for the desired domain.

All of models according to embodiments of the present disclosure, used for the quantitative and qualitative comparisons described below, were subjected to performance measurement without retraining after a single training session. In contrast, other conventional technologies (models) conducted retraining whenever the type of domain or dataset was changed.

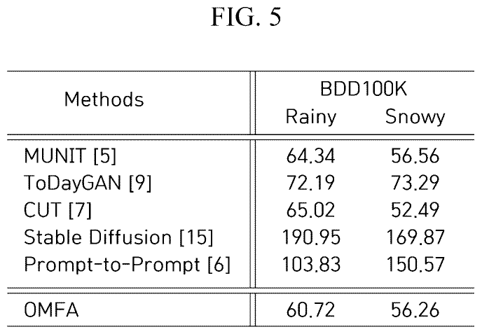

Comparisons in image translation performance of the model according to an embodiment of the present disclosure will be described below. FIG. 5 illustrates the results of performance comparisons between the model of the present disclosure and other conventional image translation models in BDD100K that is a dataset representatively used for image translation performance measurement. A metric used in the present comparison is Frechet Inception Distance (FID), which is one of indicators used to measure the quality of generated images. FID is configured to measure a data distribution distance between a set of generated images and a set of real images of a desired domain, where performance is higher as the value of FID is lower, and is calculated as represented by the following Equation 3.

$$d ( X , Y ) = {‖ {μ}_{X} - {μ}_{Y} ‖}^{2} + Tr ( {\sum }_{X} + {\sum }_{Y} - 2 \sqrt{{\sum }_{X} {\sum }_{Y}} ) \qquad [ Equation 3 ]$$

μ denotes the average, Σ denotes the covariance, and Tr denotes the sum of diagonal elements. X and Y denote features obtained as the output of pool3-layer by respectively inserting generated images and a real image to Inception-V3 model.

In order to compare the measured qualities of the generated images, two image translation tasks were established. One is a task for translating an image from a clean weather condition into a rainy condition and is referred to as ‘Rainy’, and the other is a task for translating an image into a snowy condition and is referred to as ‘Snowy’.

A GAN-based model was separately trained for each task, and translations into two domains were performed using the same model after one training session is performed according to an embodiment of the present disclosure. Stable Diffusion and Prompt-to-Prompt models used the pre-trained weights of v1-4 version trained on the LAION-5B dataset. The diffusion-based models exhibited very high FID scores, indicating a significant difference between the real image and generated images obtained from the diffusion model.

It can be seen through these results that, unless the diffusion-based model is trained especially for autonomous driving datasets, image translation is not desirably operated.

On the other hand, according to the embodiment of the present disclosure, the model of the present disclosure was trained with driving images even if it was based on the diffusion-based model, thus achieving high performance in terms of FID. In the ‘Snowy’ task, the model according to the embodiment of the present disclosure recorded a score higher than that of the CUT model by 3.77.

However, according to an embodiment of the present disclosure, the model of the present disclosure was trained to perform translation between multiple domains through one training session, and GAN-based models including the CUT model were separately trained for respective domains.

Therefore, it can be confirmed that the model according to the embodiment of the present disclosure achieved sufficiently excellent performance even under unfavorable experimental conditions.

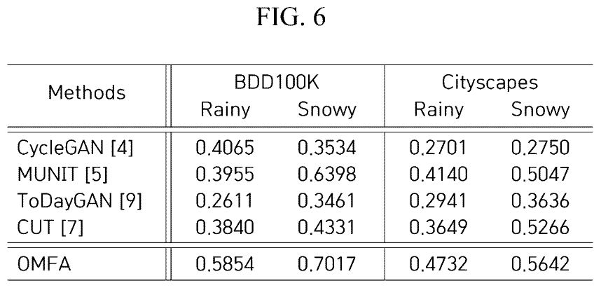

FIG. 6 illustrates the results of a quality comparison between images translated by a model according to an embodiment of the present disclosure.

In this embodiment, translated images were evaluated for BDD100K and Cityscapes, where the metric is CLIP-IQA that is one of indicators recently widely used in image quality evaluation (assessment). A Cityscapes dataset is one of datasets most widely used as driving image datasets, together with a BDD100K dataset.

CLIP in CLIP-IQA is Contrastive Language-Image Pre-Training and refers to a pre-trained model that has learned representations using image-text pairs. In recent image quality evaluation research, CLIP-IQA has been proposed to measure image quality based on CLIP models. The present disclosure shows that, by utilizing this indicator, the proposed model generates images having high quality compared to other GAN-based models. High scores exhibit high-quality images that are generated.

The model according to an embodiment of the present disclosure surpasses the performance of other models in all datasets and tasks. This result shows that the fidelity of the images generated by the model according to the embodiment of the present disclosure is higher than that of the GAN-based models.

Referring to the results illustrated in FIGS. 5 and 6, it can be confirmed that the images generated by the method according to the embodiment of the present disclosure have low FID scores and high CLIP-IQA scores compared to other conventional models. Based on these results, it can be seen that the model according to the embodiment of the present disclosure can generate high-quality images while closely matching the distribution of the real image.

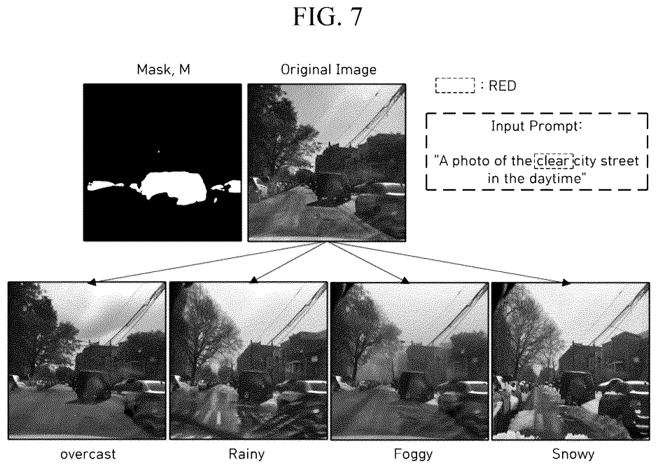

FIG. 7 illustrates result images obtained by translating an image into multiple domains using a model according to an embodiment of the present disclosure.

‘Original image’ and ‘Mask’ denote an input image and a segmentation mask, respectively, and an input prompt is “a photo of the clear city street in the daytime.” Here, results obtained when “clear” is changed to “overcast”, “rainy”, “foggy”, and “snowy” using an edit prompt, are depicted in FIG. 7.

It can be confirmed that high-quality images have been generated in conformity with respective weather domains. Further, it also can be confirmed that the shape of a vehicle was desirably maintained based on information about portions that need to be preserved, obtained from the mask.

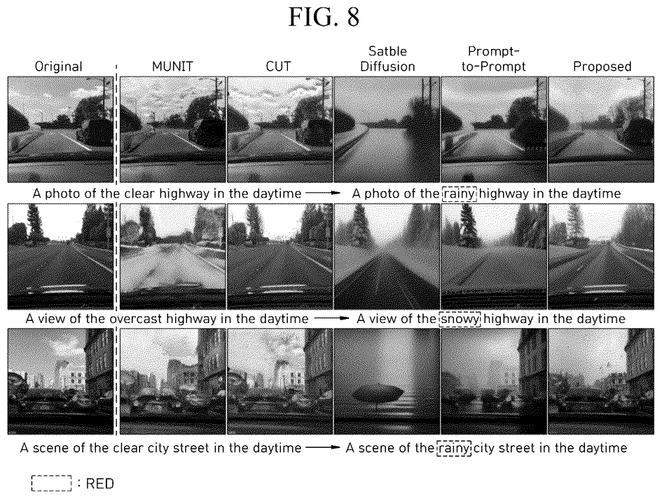

FIG. 8 illustrates the results of a qualitative comparison in image translation performance between a model according to an embodiment of the present disclosure and conventional models. Referring to FIG. 8, result pictures showing translated images, obtained when the same input image is given, are depicted.

In the drawing, the leftmost column indicates input images, and input prompts and edit prompts for respective images are indicated below the corresponding images. Referring to the result images, MUNIT and CUT models generate images close to respective domains, but artifacts attributable to the characteristics of GAN appear in the corresponding images, and those images generally exhibit low quality.

Stable Diffusion and Prompt-to-prompt models generate high-quality results, but these results have distribution greatly different from that of the input images. It can be observed that the most important elements in driving images, such as surrounding vehicles and road structures, were significantly distorted.

On the other hand, according to an embodiment of the present disclosure, it can be confirmed that domain translation was successfully performed while the overall shape of the input images was preserved. Specifically, it can be confirmed that, in a snowy domain, trees were naturally adapted to a winter environment, and in a rainy domain, raindrops were realistically depicted on vehicle windows.

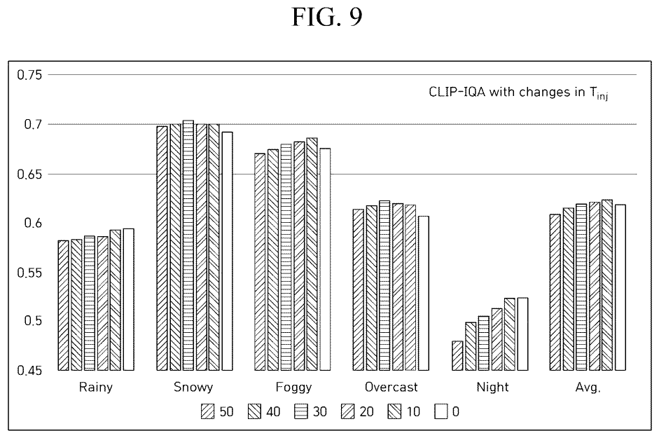

FIG. 9 illustrates a histogram of CLIP-IQA scores for respective tasks corresponding to Tᵢₙⱼ according to an embodiment of the present disclosure. FIG. 9 shows the results of CLIP-IQA for respective tasks measured while changing Tᵢₙⱼ to different values. Labels from ‘Rainy’ to ‘Night’ on the X-axis of the histogram indicate translation domain labels, and ‘Avg.’ indicates average values.

The range from ‘50’ to ‘0’ shown in a legend represents Tᵢₙⱼ values. In general, when Tᵢₙⱼ is reduced, that is, when more masked noisy versions of the original image are used, image quality is improved.

However, when masked noisy versions are used in excessively many stages, that is, when Tᵢₙⱼ is excessively reduced, a decline in image quality can be observed. Experimentally, it was confirmed that the highest image quality was achieved when Tᵢₙⱼ was between 30 and 40.

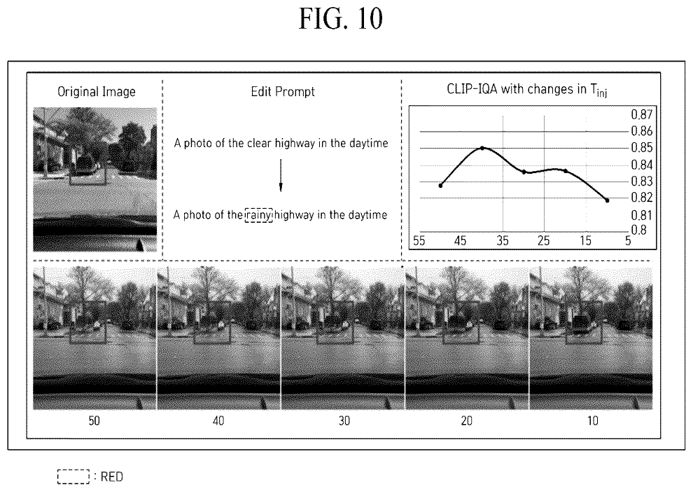

FIG. 10 illustrates the results of images generated depending on Tᵢₙⱼ values and CLIP-IQA scores according to an embodiment of the present disclosure.

FIG. 10 shows the results of generated images and CLIP-IQA scores corresponding thereto as the Tᵢₙⱼ value changes. Red boxes indicate the locations of important objects. Upon examining the result images, it can be observed that, as Tᵢₙⱼ is reduced, that is, as a noisy image derived from the original image is retained for a longer duration, the objects are better preserved in the final output. However, considering a trend in changes in CLIP-IQA scores, it can be seen that retaining the object shapes for a longer duration tends to degrade image quality.

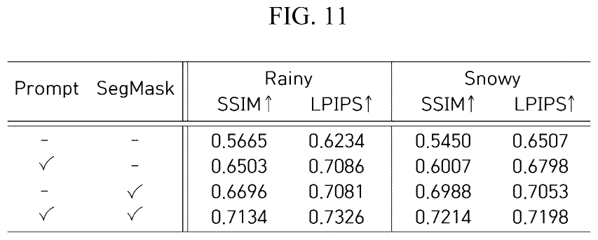

FIG. 11 illustrates the results of performance change depending on whether training using a prompt and a segmentation mask are used according to an embodiment of the present disclosure.

Referring to FIG. 11, there is a table showing the results of performance change depending on whether a prompt has been generated and a T2I model has been trained with the prompt, and whether the segmentation mask has been used.

It can be confirmed that, for all datasets and metrics, performance has improved through prompt generation and training, and the segmentation mask has also contributed to performance improvement. In particular, when the segmentation mask is used, greater performance improvement may be achieved in terms of Structural Similarity Index Measure (SSIM) that is a metric for measuring structural similarity to the input image. Finally, when both training using the prompt and the segmentation mask are used, the highest performance is exhibited.

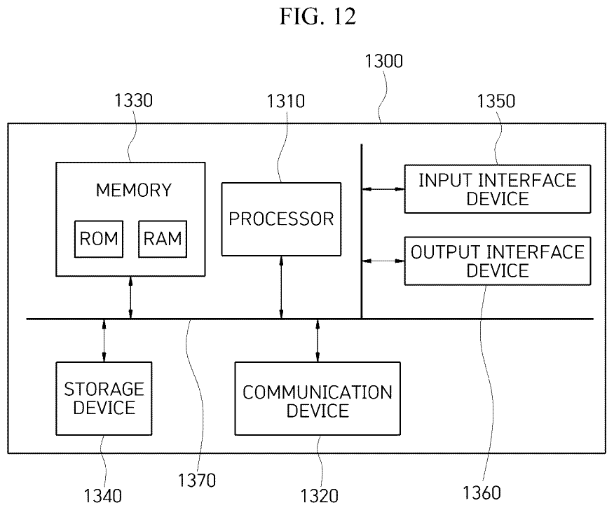

FIG. 12 is a block diagram illustrating a computer system for implementing a method according to an embodiment of the present disclosure.

A diffusion-based image translation method without requiring retraining according to an embodiment of the present disclosure includes the steps of (a) generating a prompt using information obtained from an image dataset, (b) training a text-to-image generation diffusion model using the prompt, and (c) performing image translation using the text-to-image generation diffusion model.

An edit prompt included in the prompt has a format in which only a word related to the relevant domain is modified in the input prompt corresponding to the description of an original image.

The text-to-image generation diffusion model includes a text encoder for text encoding, a U-Net composed of convolutional layers for denoising, and an image decoder for image generation.

Step (c) improves the quality of the translated image by delivering information about a translation target domain and a translation target image area to an image translation model.

At step (c), a noisy image is acquired using a Denoising Diffusion Implicit Model (DDIM) process, and information about portions that need to be modified in an image translation process is obtained using a prompt-to-prompt algorithm.

At step (c), when a target domain is input to the text-to-image generation diffusion model trained with a prompt having a desired format, the original image is translated into an image of the desired domain without requiring retraining.

At step (c), translation is performed using a segmentation mask in consideration of the need to preserve image context information.

At step (c), control related to a time step that is the target of information delivery in a denoising process is performed.

Referring to FIG. 12, a computer system 1300 may include at least one of a processor 1310, a memory 1330, an input interface device 1350, an output interface device 1360, and a storage device 1340, which communicate with each other through a bus 1370. The computer system 1300 may further include a communication device 1320 connected to a network. The processor 1310 may be a Central Processing Unit (CPU) or a semiconductor device for executing processing instructions stored in the memory 1330 or the storage device 1340. Each of the memory 1330 and the storage device 1340 may be any of various types of volatile or nonvolatile storage media. For example, the memory 1330 may include a Read-Only Memory (ROM) and a Random Access Memory (RAM). In an embodiment of the disclosure, the memory may be located inside or outside the processor, and may be connected to the processor through various means that are already known. The memory may be any of various types of volatile or nonvolatile storage media, and may include, for example, Read-Only Memory (ROM) or Random Access Memory (RAM).

A diffusion-based image translation system without requiring retraining according to an embodiment of the present disclosure may include a memory 1330 in which a program for generating a prompt using information obtained from an image dataset and training a text-to-image generation diffusion model using the prompt is stored, and a processor 1310 which executes the program. Here, the processor 1310 performs image translation using the text-to-image generation diffusion model.

The text-to-image generation diffusion model includes a text encoder for text encoding, a U-Net composed of convolutional layers for denoising, and an image decoder for image generation.

The processor 1310 performs image translation by acquiring a noisy image using a Denoising Diffusion Implicit Model (DDIM) process and by obtaining information about portions that need to be modified in an image translation process using a prompt-to-prompt algorithm.

The processor 1310 performs translation into an image of a desired domain without requiring retraining, as a target domain is input to the text-to-image generation diffusion model trained with a prompt having a desired format.

The processor 1310 performs translation using a segmentation mask in consideration of information that needs to be preserved.

The processor 1310 performs control related to a time step that is the target of information delivery in a denoising process.

Therefore, the embodiment of the present disclosure may be implemented either as a method implemented in a computer or as a non-transitory computer-readable medium in which computer-executable instructions are stored. In an embodiment, when executed by the processor, the computer-readable instructions may perform a method according to at least one aspect of the present disclosure.

The communication device 1320 may transmit or receive a wired signal or a wireless signal.

Furthermore, the method according to an embodiment of the present disclosure may be implemented in the form of program instructions executable through various types of computer means, and may be recorded on a computer-readable medium.

The computer-readable medium may include program instructions, data files, data structures, or the like, either alone or in combination. The program instructions recorded on the computer-readable medium may be specially designed and configured for implementing the present disclosure, or may be known and available to those skilled in the field of computer software. A computer-readable recording medium may include hardware devices configured to store and execute program instructions. For example, the computer-readable recording medium may include magnetic media such as a hard disk, a floppy disk, and magnetic tape, optical media such as CD-ROMs and DVDs, magneto-optical media such as a floptical disk, ROM, RAM, and flash memory. The program instructions may include not only machine code, such as code produced by a compiler, but also high-level language code that can be executed by a computer using an interpreter or the like.

While the embodiments of the present disclosure have been described in detail above, it should be understood that the scope of the present disclosure is not limited thereto. Various modifications and alterations made by those skilled in the art, based on the basic concept of the disclosure defined in the accompanying claims, may also fall within the scope of the present disclosure.

What is claimed is:

1. A diffusion-based image translation method without requiring retraining, performed by a diffusion-based image translation system, the diffusion-based image translation method comprising:
(a) generating a prompt using information obtained from an image dataset;
(b) training a text-to-image generation diffusion model using the prompt; and
(c) performing image translation using the text-to-image generation diffusion model.

2. The diffusion-based image translation method as claimed in claim 1, wherein an edit prompt included in the prompt has a format in which only a word related to a relevant domain is modified in an input prompt corresponding to description of an original image.

3. The diffusion-based image translation method as claimed in claim 1, wherein the text-to-image generation diffusion model comprises a text encoder for text encoding, a U-Net composed of convolutional layers for denoising, and an image decoder for image generation.

4. The diffusion-based image translation method as claimed in claim 1, wherein (c) comprises:
improving a quality of a translated image by delivering information about a translation target domain and a translation target image area to an image translation model.

5. The diffusion-based image translation method as claimed in claim 4, wherein (c) further comprises:
acquiring a noisy image using a Denoising Diffusion Implicit Model (DDIM) process, and obtaining information about a portion that needs to be modified in an image translation process using a prompt-to-prompt algorithm.

6. The diffusion-based image translation method as claimed in claim 1, wherein (c) comprises:
when a target domain is input to the text-to-image generation diffusion model trained with a prompt having a desired format, performing translation into an image of a desired domain without requiring retraining.

7. The diffusion-based image translation method as claimed in claim 1, wherein (c) comprises:
performing translation using a segmentation mask in consideration of a need to preserve image context information.

8. The diffusion-based image translation method as claimed in claim 1, wherein (c) comprises:
performing control related to a time step that is a target of information delivery in a denoising process.

9. A diffusion-based image translation system without requiring retraining, comprising:
a memory configured to store a program for generating a prompt using information obtained from an image dataset and training a text-to-image generation diffusion model using the prompt; and
a processor configured to execute the program,
wherein the processor performs image translation using the text-to-image generation diffusion model.

10. The diffusion-based image translation system as claimed in claim 9, wherein the text-to-image generation diffusion model comprises a text encoder for text encoding, a U-Net composed of convolutional layers for denoising, and an image decoder for image generation.

11. The diffusion-based image translation system as claimed in claim 9, wherein the processor performs image translation by acquiring a noisy image using a Denoising Diffusion Implicit Model (DDIM) process and by obtaining information about a portion that needs to be modified in an image translation process using a prompt-to-prompt algorithm.

12. The diffusion-based image translation system as claimed in claim 9, wherein the processor performs translation into an image of a desired domain without requiring retraining, as a target domain is input to the text-to-image generation diffusion model trained with a prompt having a desired format.

13. The diffusion-based image translation system as claimed in claim 9, wherein the processor performs translation using a segmentation mask in consideration of information that needs to be preserved.

14. The diffusion-based image translation system as claimed in claim 9, wherein the processor performs control related to a time step that is a target of information delivery in a denoising process.
